(19) United States
(12) Patent Application Publication
(10) Pub. No.: US 2002/0037242 A1
(43) Pub. Date: Mar. 28, 2002

(54) METAL CARRIER FOR A CATALYST

(76) Inventors: MASAHARU NAKAMORI, SAITAMA (JP); KATSUNORI OKUBO, SAITAMA (JP); MASASHI YOKOYAMA, SAITAMA (JP); HIROSHI KATO, SAITAMA (JP)

Correspondence Address: BIRCH STEWART KOLASCH & BIRCH, PO BOX 747, FALLS CHURCH, VA, 22040-0747, US

(21) Appl. No.: 09/217,633

(22) Filed: Dec. 22, 1998

(30) Foreign Application Priority Data
Jan. 8, 1998 (JP) HEI-10-002302

(51) Int. Cl. B01D 53/74; B01J 32/00; B01J 35/04; F01N 3/28

(52) U.S. Cl. 422/180; 422/177; 502/439

(57) ABSTRACT

A metal carrier for a catalyst having a cylindrical case with an excellent high temperature oxidation resistance. A metal carrier for the catalyst includes a honeycomb structure which is in a cylindrical form and has plural air vents extending in an axial direction. The cylindrical case covers the periphery of the honeycomb structure. The cylindrical case is made of ferritic stainless steel containing Mo. The present invention makes it possible to avoid the occurrence of abnormal oxidation of the cylindrical case at high temperature.

### BACKGROUND OF THE INVENTION

1. Field of the Invention

The present invention relates to a metal carrier for a catalyst, and more particularly to an improvement in a metal carrier for a catalyst comprising a honeycomb structure which is in a cylindrical form and has plural air vents extending in its axial direction, and a cylindrical case covering the periphery of the honeycomb structure.

2. Description of Background Art

Such a type of metal carrier is fitted to an exhausting system of a vehicle in a state where a catalyst for cleaning exhaust gas is formed on the honeycomb structure of the catalyst.

For example, in motorcycles, particularly motorcycles wherein a small size, namely a 2-cycle engine is mounted, the metal carrier is fitted to the inside of a muffler. This mounting is due to a restriction in the arrangement thereof and the like. Thus, an opening portion at one end of the metal carrier case is welded to the outlet of the exhaust pipe. For this reason, the metal carrier is exposed to a high temperature of, for example, 900° C. or higher.

In this case, the honeycomb structure is covered with a catalyst layer and thus oxidation thereof does not come into question very much. However, the periphery of the case is exposed and, in consequence, oxidation thereof rapidly advances when the case is exposed to high temperature. In other words, abnormal oxidation may be introduced.

### SUMMARY AND OBJECTS OF THE INVENTION

An object of the present invention is to provide a metal carrier for a catalyst, in which high temperature oxidation resistance of the metal carrier case is greatly improved.

According to the present invention, in order to attain the object, a metal carrier is provided for a catalyst comprising a honeycomb structure that is in a cylindrical form and has plural air vents extending in an axial direction of the metal carrier. A cylindrical case covers the periphery of the honeycomb structure. The cylindrical case is composed of ferritic stainless steel containing Mo.

Specifying the material of the case as being ferritic stainless steel containing Mo causes high temperature oxidation resistance of the case to be greatly improved, and makes it possible to avoid abnormal oxidation thereof Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a cleaner for exhaust gas;

FIG. 2 is an enlarged cross-sectional view of an important portion in FIG. 1;

FIG. 3 is a graph showing an example of the relationship between heating temperature and oxidation increase;

FIG. 4 is a graph showing another example of the relationship between heating temperature and oxidation increase; and

FIG. 5 is a cross-sectional view of an important portion showing the arrangement relationship among an exhaust pipe, a muffler and a cleaner.

### DETAILED DESCRIPTION OF THE PREFERRED EMBODIMENTS

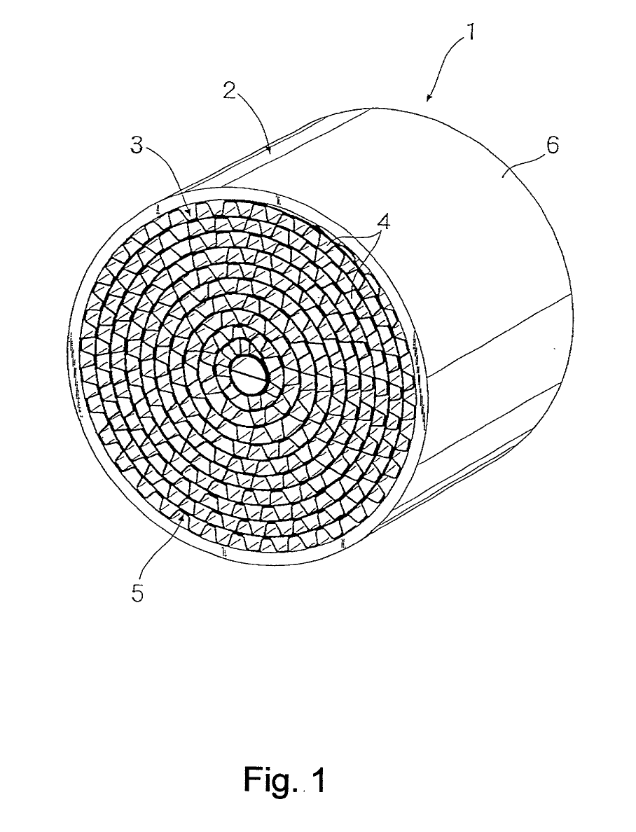

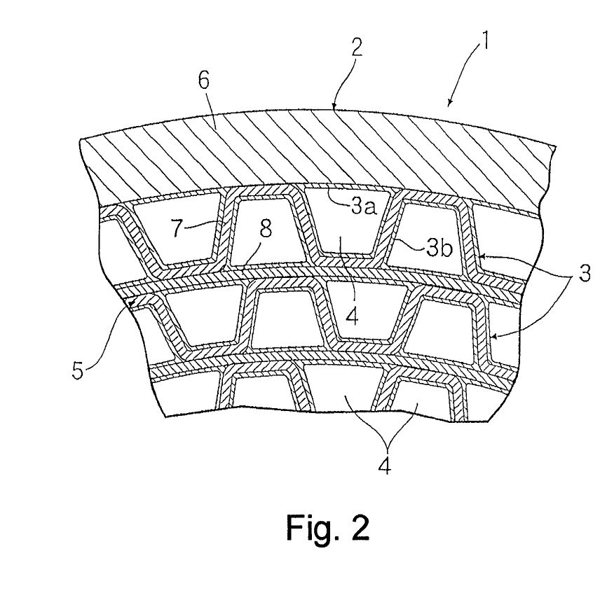

In FIGS. 1 and 2, a cleaner 1 for exhaust gas that is fitted to an exhausting system of a motorcycle is composed of a metal carrier 2 for a catalyst and a catalyst layer 3 carried thereon. The metal carrier 2 has a honeycomb structure 5 which is in a cylindrical form and has plural air vents 4 extending in the axial direction of the metal carrier 2. A cylindrical case 6 covers the periphery of the honeycomb structure 5. In this embodiment, the plural air vents 4 existing at the outermost position of the honeycomb structure 5 are formed by cooperation of the inner face of the case 6 and a waved plate 7 of the honeycomb structure 5. The catalyst layer 3 is formed or carried on the honeycomb structure 5 after sintering treatment of the inner face of the respective air vents 4.

The waved plates 7 and base plates 8 of the honeycomb structures are made of ferritic stainless steel, for example, widely used ferritic stainless steel containing no Mo.

The case 6 is composed of a seam welded pipe comprising ferritic stainless steel containing Mo. The Mo content in this ferritic stainless steel is preferably set into the range of 0.30 wt %≦Mo≦2.50 wt %.

Specifying the material of the case 6 as above causes a great improvement in to resist high temperature oxidation of the case 6 and makes it possible to avoid abnormal oxidation thereof Besides, since the material of the case 6 is the same as that of the honeycomb structures, a difference in the coefficient of linear expansion between the case and the honeycomb structures is small, thereby greatly suppressing thermal deformation of the case 6 based on the difference. In addition, when the case 6 is welded to the outlet of the exhaust pipe, weldability thereof is increased.

Concerning the Mo content, in the case of Mo<0.30 wt %, the effect of high temperature oxidation resistance of the case 6 is somewhat insufficient. On the other hand, in the case of Mo>2.50 wt %, the Mo content is remarkably larger than ordinary standardized materials, thereby raising material cost. Thus, such a material is unsuitable for a constituting material of the cases for mass production.

The following will explain the high temperature oxidation resistance of the material constituting the case 6, and practical vehicle endurance tests.

[1] High Temperature Oxidation Resistance

Table 1 shows compositions of Examples 1-3 of ferritic stainless steel.

TABLE 1

| Ferritic | | | | | | | | | | |
|---|---|---|---|---|---|---|---|---|---|---|
| stainless | Chemical components (wt %) | | | | | | | | | |
| steel | C | Si | Mn | P | S | Cr | Ti | Mo | Cu | Nb |
| Example 1 | 0.005 | 0.06 | 0.12 | 0.030 | 0.004 | 17.33 | 0.21 | 1.20 | — | — |
| Example 2 | 0.05 | 0.28 | 0.13 | 0.025 | 0.01 | 0.01 | — | — | — | — |
| Example 3 | 0.02 | 0.04 | 0.19 | 0.023 | 0.003 | 0.003 | — | — | 0.46 | 0.44 |

In Examples 1-3, test pieces having a thickness of 1.0 mm and the same surface area were produced, and then the test pieces were set inside a heating furnace under atmospheric pressure. The heating temperature was then raised to a predetermined value, and the raised temperature was maintained for 20 hours. Subsequently, the oxidation increase (wt %) of the respective test pieces was obtained. This measuring operation was repeated for a given number of times.

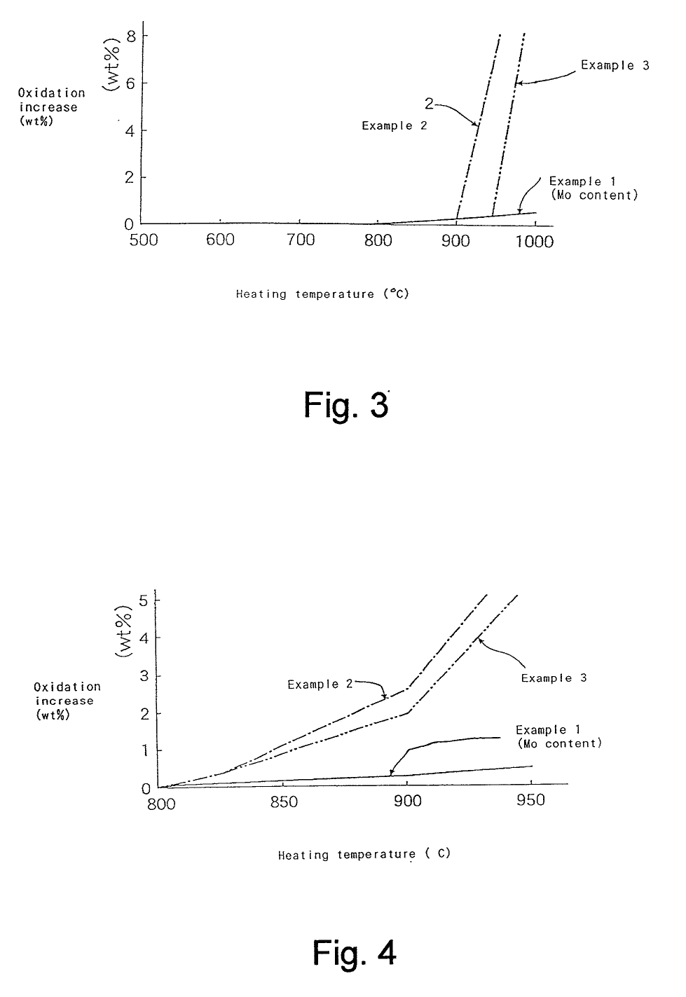

FIG. 3 shows the results of the measurement. In this figure, Examples 1-3 correspond to Examples 1-3 in Table 1, respectively. As shown in FIG. 3, when the heating temperature was over about 800° C., oxidation in Examples 1-3 started. However, in the case of Example 1, which contained Mo, the oxidation increase was merely about 0.57 wt % even at a heating temperature of 1000° C. This made it clear that Example 1 had an excellent high temperature oxidation resistance. On the other hand, abnormal oxidation arose at a heating temperature of about 900° C. or more in Example 2, and at a temperature of about 950° C. or more in Example 3, respectively.

Next, the inside of the furnace was maintained in a moisture added atmosphere and then the same measuring operation as above was repeated for a given number of times. In this case, the moisture added atmosphere comprised a 90 vol % of a mixture gas (0.5 vol % of oxygen and the balance of nitrogen) and a 10 vol % of water.

FIG. 4 shows the results of the measurement. In FIG. 4, Examples 1-3 corresponds to Examples 1-3 in Table 1, respectively. As shown in FIG. 4, in the case of Example 1, that contained Mo, the increase in the oxidation of the case was about 0.48 wt % at a heating temperature of 950° C. This made it clear that Example 1 also had an excellent high temperature oxidation resistance in the moisture added atmosphere. On the other hand, abnormal oxidation arose at a heating temperature of about 900° C. or more in Examples 2 and 3.

[II] Practical Vehicle Endurance Test

A catalyst layer 3 having a noble metal such as platinum was carried on the metal carrier 2 for a catalyst having the case 6 made of Example 1. In this way, the cleaner 1 of Example 1 was obtained. The same catalyst layer 3 as above was formed or carried on two kinds of metal carriers 2 for a catalyst which had the case 6 and were made of Examples 2 and 3 to obtain the cleaners 1 of Examples 2 and 3.

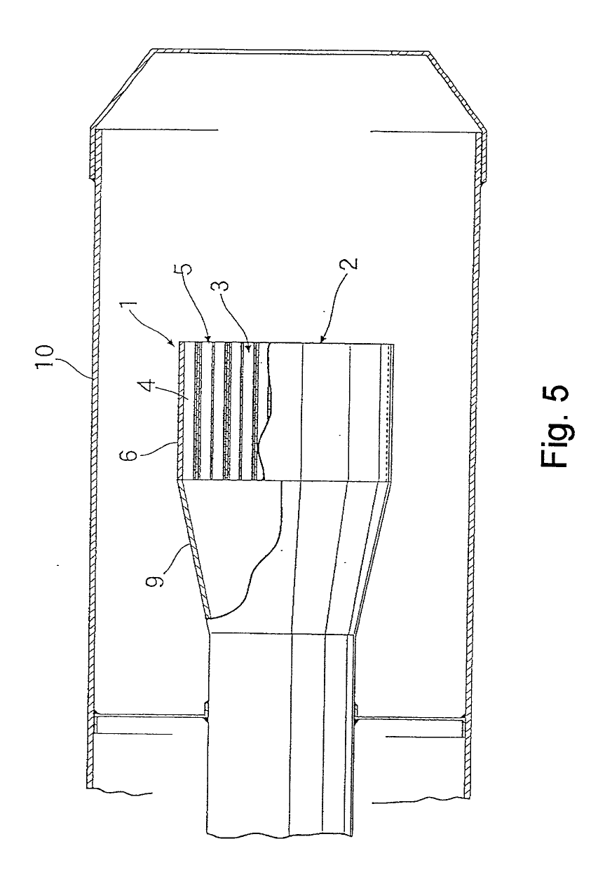

As shown in FIG. 5, in an exhausting system of a small size 2-cycle engine mounted on a motorcycle, an opening portion at one end of the case 6 was welded to the outlet of the exhaust pipe 9 so that the metal carrier 2, that is, the cleaner 1 of Example 1 was positioned inside the muffler 10. The engine was then driven for a specified period, and subsequently the state of the case 6 was examined. During the driving of the engine, the temperature inside the muffler 10 at a distance of 20 cm behind the cleaner 1 was about 900° C. The same test was carried out for the cleaners of Examples 2 and 3

Table 2 shows the results of the test.

TABLE 2

State of the case after the test

| Cleaner | Abnormal oxidation | Deformation |
|---|---|---|
| Example 1 | No outbreak | Almost none |
| Example 2 | Outbreak in its whole | Large |
| Example 3 | Outbreak in its part | Small |

From Table 2, it can be understood that the case 6 of the cleaner 1 of Example 1 had an excellent high temperature oxidation resistance end good deformation resistance. Thus, the exhaust gas cleaning ability of Example 1 is maintained for a long time.

From Table 2, it is also clear that the cleaners 1 of Examples 2 and 3 were not practical. In particular, the catalyst layer 3 of Example 2 was subjected to EPMA (XMA) analysis. As a result, a portion 3a (see FIG. 2), of the catalyst layer 3, adhering to the inner face of the case 6 was covered with en oxide resulting from abnormal oxidation, and further an Fe component was detected at a portion 3b (see FIG. 2), of the catalyst layer 3, adhering to the honeycomb structure 5. The exhaust gas cleaning ability of this cleaner 1 of Example 2 was greatly reduced, as compared with its initial value.

According to the present invention, a metal carrier for a catalyst is provided wherein high temperature oxidation resistance of its case is greatly improved by the aforementioned structure.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A metal carrier for a catalyst comprising:
a honeycomb structure shaped in a cylindrical form, said honeycomb structure having a plurality of air vents extending in an axial direction thereof; and
a cylindrical case covering an outer peripheral surface of the honeycomb structure, wherein the cylindrical case is composed of ferritic stainless steel containing Mo.

2. The metal carrier for a catalyst according to claim 1, wherein the Mo content in the ferritic stainless steel is in the range of 0.30 wt %≦Mo≦2.50 wt %.

3. The metal carrier for a catalyst according to claim 1, and further including a muffler housing wherein said cylindrical case is disposed within said muffler housing and is displaced a predetermined distance relative to an interior wall of the muffler housing to form a space therebetween.

4. The metal carrier for a catalyst according to claim 1, wherein the honeycomb structure is constructed of ferritic stainless steel that does not contain Mo.

5. The metal carrier for a catalyst according to claim 1, wherein the Mo content is 1.20 wt %.

6. The metal carrier for a catalyst according to claim 1, and further including a catalyst layer of a noble metal formed on the honeycomb structure.

7. The metal carrier for a catalyst according to claim 6, wherein the noble metal is platinum.

8. A metal carrier for a catalyst comprising:
a honeycomb structure having a catalyst layer formed thereon, said honeycomb structure having a plurality of air vents extending in a flow direction through the honeycomb structure; and
a cylindrical case covering an outer surface of the honeycomb structure, wherein the cylindrical case is composed of ferritic stainless steel containing Mo.

9. The metal carrier for a catalyst according to claim 8, wherein the Mo content in the ferritic stainless steel is in the range of 0.30 wt %≦Mo≦2.50 wt %.

10. The metal carrier for a catalyst according to claim 8, and further including a muffler housing wherein said cylindrical case is disposed within said muffler housing and is displaced a predetermined distance relative to an interior wall of the muffler housing to form a space therebetween.

11. The metal carrier for a catalyst according to claim 8, wherein the honeycomb structure is constructed of ferritic stainless steel that does not contain Mo.

12. The metal carrier for a catalyst according to claim 8, wherein the Mo content is 1.20 wt %.

13. The metal carrier for a catalyst according to claim 8, wherein the catalyst layer is a noble metal formed on the honeycomb structure.

14. The metal carrier for a catalyst according to claim 13, wherein the noble metal is platinum.
